(19) United States
(12) Patent Application Publication
(10) Pub. No.: US 2025/0378648 A1
(43) Pub. Date: Dec. 11, 2025

(54) SUBTITLE DISPLAY METHOD, SUBTITLE DISPLAY SYSTEM, AND ELECTRONIC DEVICE

(71) Applicant: XIAO-I PLUS INC., Wilmington, DE (US)

(72) Inventors: Hui YUAN, Wilmington, DE (US); Lingli WU, Wilmington, DE (US); Xincheng ZUO, Wilmington, DE (US); Elisa CHENG, Wilmington, DE (US)

(73) Assignee: XIAO-I PLUS INC., Wilmington, DE (US)

(21) Appl. No.: 18/734,425

(22) Filed: Jun. 5, 2024

(51) Int. Cl. G06T 19/00; G06F 3/04845; G10L 15/26; H04N 21/488

(52) U.S. Cl. CPC G06T 19/006; G06F 3/04845; G10L 15/26; H04N 21/4884

(57) ABSTRACT

Disclosed is a subtitle display method, applied to augmented reality glasses, and the augmented reality glasses are connected to a user terminal. The method includes: capturing, by the augmented reality glasses, a phone audio sent by the user terminal, where the phone audio is used to represent audio information generated during an incoming call or an outgoing call; acquiring, by the augmented reality glasses based on the phone audio, a text corresponding to the phone audio; and displaying, by the augmented reality glasses by using subtitles, the text corresponding to the phone audio. This can provide a subtitle service in augmented reality glasses, improving user experience, especially improving quality of life of a hearing-impaired person.

### TECHNICAL FIELD

The present disclosure relates to the field of subtitle display, and in particular, to a subtitle display method, a subtitle display system, and an electronic device.

### BACKGROUND

With the rapid development of science and technology, Augmented Reality (AR) technologies have been applied to every aspect of our life, bringing unprecedented experience and convenience. In the field of games, the AR technologies can provide an immersive game environment, allowing players to feel as if they are in the game world. In the field of education, the AR technologies can present abstract knowledge points in an intuitive and interactive manner, greatly improving learning efficiency and interest. In the medical field, the AR technologies assist doctors in surgical simulation and disease diagnosis, improving accuracy and safety of medical treatment. However, although the AR technologies have brought a wide range of benefits to society, there are still many challenges for hearing-impaired people in their daily lives.

Hearing-impaired people are often troubled by a lack of timely access to conversations when they watch movies, television, attend public presentations, or the like. Conventional subtitle services are usually limited to screens and cannot provide personalized viewing experience. In addition, subtitle services in public places often require additional device support, which not only increases costs, but also brings inconvenience in operation.

### SUMMARY

Embodiments of the present disclosure provide a subtitle display method, a subtitle display system, and an electronic device, so that a subtitle service in augmented reality glasses can be provided, thereby improving user experience, and in particular, improving quality of life of hearing-impaired people.

According to a first aspect of the present disclosure, a subtitle display method is provided and applied to augmented reality glasses, the augmented reality glasses are connected to a user terminal, and the method includes: capturing, by the augmented reality glasses, a phone audio sent by the user terminal, where the phone audio is used to represent audio information generated during an incoming call or an outgoing call; acquiring, by the augmented reality glasses based on the phone audio, a text corresponding to the phone audio; and displaying, by the augmented reality glasses by using subtitles, the text corresponding to the phone audio.

In some embodiments, the method further includes: when a phone status is call in progress, receiving, by the augmented reality glasses, a phone audio capture instruction sent by the user terminal, where the capturing, by the augmented reality glasses, a phone audio sent by the user terminal includes: capturing, by the augmented reality glasses, the phone audio according to the phone audio capture instruction.

In some embodiments, the acquiring, by the augmented reality glasses based on the phone audio, a text corresponding to the phone audio includes: sending, by the augmented reality glasses, the phone audio to the user terminal, so that the user terminal acquires, based on the phone audio, the text corresponding to the phone audio and sends the text corresponding to the phone audio to the augmented reality glasses.

In some embodiments, the acquiring, by the augmented reality glasses based on the phone audio, a text corresponding to the phone audio includes: uploading, by the augmented reality glasses, the phone audio to a cloud server, so that the cloud server performs voice transcription on the phone audio to acquire the text corresponding to the phone audio and returns the text corresponding to the phone audio to the augmented reality glasses.

In some embodiments, the method further includes: acquiring, by the augmented reality glasses, a text corresponding to an audio stream of an audio or a video played by the user terminal; and displaying, by the augmented reality glasses by using subtitles, the text corresponding to the audio stream of the audio or the video.

In some embodiments, the method further includes: capturing, by the augmented reality glasses by using a linear microphone array, an ambient audio by using a beamforming technology; acquiring, by the augmented reality glasses based on the ambient audio, a text corresponding to the ambient audio; and displaying, by the augmented reality glasses by using subtitles, the text corresponding to the ambient audio.

In some embodiments, the method further includes: performing, by the augmented reality glasses, signal processing on the ambient audio, where the signal processing includes at least one of following: filtering processing, noise reduction processing, or echo cancellation processing. The acquiring, by the augmented reality glasses based on the ambient audio, a text corresponding to the ambient audio includes: acquiring, by the augmented reality glasses based on an ambient audio obtained after the signal processing, the text corresponding to the ambient audio.

In some embodiments, the method further includes: performing, by the augmented reality glasses, parameter adjustment by using a depth learning model or a machine learning model, where the parameter adjustment includes at least one of following: beamforming parameter adjustment or signal processing parameter adjustment. The capturing an ambient audio by using a beamforming technology includes: capturing the ambient audio by using an adjusted beamforming parameter. The performing, by the augmented reality glasses, signal processing on the ambient audio includes: performing, by the augmented reality glasses, signal processing on the ambient audio based on an adjusted signal processing parameter.

In some embodiments, the method further includes: receiving, by the augmented reality glasses, a subtitle adjustment instruction sent by the user terminal, and performing adjustment of a position, a size, or a color on the subtitles according to the subtitle adjustment instruction.

According to a second aspect of the present disclosure, a subtitle display method is provided, including: acquiring, by a user terminal, audio information, where the audio information includes an ambient audio or a phone audio sent by augmented reality glasses connected to the user terminal, or an audio stream of an audio or a video played by the user terminal; uploading, by the user terminal, the audio information to a cloud server, so that the cloud server performs voice transcription on the audio information to acquire a text corresponding to the audio information; receiving, by the user terminal, the text, sent by the cloud server, corresponding to the audio information; and displaying, by the user terminal by using subtitles, the text corresponding to the audio information.

In some embodiments, the method further includes: sending, by the user terminal, the text corresponding to the audio information to the augmented reality glasses, so that the augmented reality glasses display, by using subtitles, the text corresponding to the audio information.

In some embodiments, the displaying, by the user terminal by using subtitles, the text corresponding to the audio information includes: displaying, by the user terminal in a floating box by using subtitles, the text corresponding to the audio information.

In some embodiments, the method further includes: when there is an incoming call or an outgoing call, monitoring, by the user terminal, a phone status; and when the phone status is call in progress, sending, by the user terminal, a phone audio capture instruction to the augmented reality glasses, so that the augmented reality glasses capture the phone audio according to the phone audio capture instruction.

In some embodiments, the method further includes: sending, by the user terminal, a subtitle adjustment instruction to the augmented reality glasses, so that the augmented reality glasses perform adjustment of a position, a size, or a color on the subtitles according to the subtitle adjustment instruction.

According to a third aspect of the present disclosure, an electronic device is provided, where the electronic device includes: a processor; and a memory, configured to store executable instructions of the processor. The processor is configured to execute the method according to the first aspect.

In some embodiments, the electronic device includes augmented reality glasses.

In some embodiments, the augmented reality glasses include a linear microphone array, and the linear microphone array includes a plurality of microphone sensors distributed along a straight line.

In some embodiments, the augmented reality glasses include wearing glasses for a hearing-impaired person.

According to a fourth aspect of the present disclosure, an electronic device is provided, where the electronic device includes: a processor; and a memory configured to store an instruction executable by the processor. The processor is configured to implement the method according to the second aspect.

According to a fifth aspect of the present disclosure, a subtitle display system is provided, including: augmented reality glasses, a user terminal, and a cloud server, where the user terminal is configured to obtain audio information. The audio information includes an ambient audio or a phone audio sent by the augmented reality glasses, or an audio stream of an audio or a video played by the user terminal. The user terminal is further configured to upload the audio information to the cloud server, so that the cloud server performs voice transcription on the audio information to acquire a text corresponding to the audio information and returns the text corresponding to the audio information to the user terminal. The user terminal is further configured to display, by using subtitles, the text corresponding to the audio information, and send the text corresponding to the audio information to the augmented reality glasses. The augmented reality glasses are configured to display, by using subtitles, the text corresponding to the audio information.

According to a sixth aspect of the present disclosure, a non-transitory computer-readable storage medium is provided, where computer executable instructions are stored on the non-transitory computer-readable storage medium. When the computer executable instructions are executed by a processor, the method in the first aspect or the second aspect is implemented.

According to a seventh aspect of the present disclosure, a computer program product including instructions is provided. When the instructions are run on a computer, the computer executes the method according to the first aspect or the second aspect.

According to a plurality of embodiments provided in the present disclosure, augmented reality glasses capture a phone audio sent by a user terminal, and acquire, based on the phone audio, a text corresponding to the phone audio; and the augmented reality glasses display, by using subtitles, the text corresponding to the phone audio. The present disclosure can display subtitles during a call on lens of the augmented reality glasses in real time, assist user communication, and improve user experience. In particular, the present disclosure can solve a problem of hearing-impaired people having difficulty in obtaining information during a call, allowing them to communicate on a phone as easily as normal people, greatly improving quality of life of hearing-impaired people, and helping them better integrate into society to enjoy colorful cultural life.

### BRIEF DESCRIPTION OF THE DRAWINGS

To describe the technical solutions in embodiments of the present disclosure more clearly, the drawings for describing the embodiments are briefly described below. Apparently, the drawings described below show only some of the embodiments of the present disclosure, and ordinary persons skilled in the art may further derive other drawings from these drawings without creative efforts.

FIG. 1 is a schematic diagram of a subtitle display system according to an embodiment of the present disclosure.

FIG. 2 is a schematic flowchart of a subtitle display method according to an embodiment of the present disclosure.

FIG. 3 is a schematic flowchart of a subtitle display method according to another embodiment of the present disclosure.

FIG. 4 is a schematic flowchart of a subtitle display method according to another embodiment of the present disclosure.

FIG. 5 is a schematic structural diagram of a subtitle display apparatus according to an embodiment of the present disclosure.

FIG. 6 is a schematic structural diagram of a subtitle display apparatus according to another embodiment of the present disclosure.

FIG. 7 is a schematic structural diagram of an electronic device according to an embodiment of the present disclosure.

### DETAILED DESCRIPTION OF THE EMBODIMENTS

The following clearly describes the technical solutions in embodiments of the present disclosure with reference to the accompanying drawings in embodiments of the present disclosure. Apparently, the described embodiments are merely some but not all of the embodiments of the present disclosure. All other embodiments obtained by a person of ordinary skill in the art based on embodiments of the present disclosure without creative efforts fall within the protection scope of present disclosure.

### System Architecture

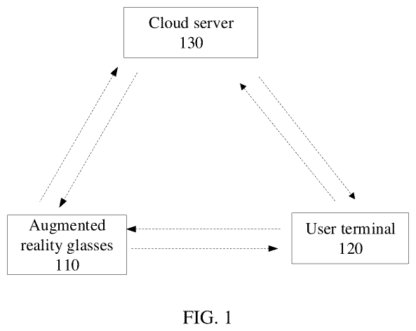

An embodiment of the present disclosure provides a subtitle display system. As shown in FIG. 1, the subtitle display system includes augmented reality glasses 110, a user terminal 120, and a cloud server 130. An application (APP) that matches the augmented reality glasses 110 is disposed in the user terminal 120. The augmented reality glasses 110 are connected to the user terminal 120 in a wired or wireless manner, and the augmented reality glasses 110 and the user terminal 120 are separately connected to the cloud server 130 in a wireless manner.

The augmented reality glasses 110 are disposed with a linear microphone array, and the augmented reality glasses 110 may capture an ambient audio by using the linear microphone array. In some embodiments, the augmented reality glasses 110 may directly upload the ambient audio to the cloud server 130, so that the cloud server 130 performs voice transcription on the ambient audio to obtain a text corresponding to the ambient audio and sends the text corresponding to the ambient audio to the augmented reality glasses 110. In some other embodiments, the augmented reality glasses 110 may alternatively send the ambient audio to the user terminal 120. The user terminal 120 uploads the ambient audio to the cloud server 130 to acquire a text corresponding to the ambient audio, and then sends the text corresponding to the ambient audio to the augmented reality glasses 110. The augmented reality glasses 110 display, by using subtitles, the text corresponding to the ambient audio. It should be noted that, the user terminal 120 may also synchronously display, in real time by using subtitles, the text corresponding to the ambient audio.

In addition, when there is an incoming call or an outgoing call, the augmented reality glasses 110 may capture a phone audio sent by the user terminal 120, where the phone audio is used to represent audio information generated during an incoming call or an outgoing call; the augmented reality glasses 110 acquire, based on the phone audio, a text corresponding to the phone audio; and the augmented reality glasses 110 display, by using subtitles, the text corresponding to the phone audio.

In some embodiments, the augmented reality glasses 110 may send the phone audio to the user terminal 120, and the user terminal 120 uploads the phone audio to the cloud server 130 to acquire a text corresponding to the phone audio, and then sends the text corresponding to the phone audio to the augmented reality glasses 110. The augmented reality glasses 110 display, by using subtitles, the text corresponding to the phone audio. In some other embodiments, the augmented reality glasses 110 may upload the phone audio to the cloud server 130, so that the cloud server 130 performs voice transcription on the phone audio to acquire the text corresponding to the phone audio and returns the text corresponding to the phone audio to the augmented reality glasses 110. Similarly, the user terminal 120 may also synchronously display, in real time by using subtitles, the text corresponding to the phone audio.

In addition, the user terminal 120 may invoke an Application Program Interface (API) provided by an operating system. For example, Accessibility Services of the Android system or VoiceOver of the iOS system enable the user terminal 120 to capture audio output in a system range. When a video application or another audio or video of the user terminal 120 is enabled, the APP, matching the augmented reality glasses 110, of the user terminal may extract an audio stream of an audio or a video and upload the audio stream to the cloud server 130, so that the cloud server 130 performs voice transcription on the audio stream to acquire a text corresponding to the audio stream and returns the text corresponding to the audio stream to the user terminal 120. The user terminal 120 displays, by using subtitles, the text corresponding to the audio stream, and sends the text corresponding to the audio stream to the augmented reality glasses 110. The augmented reality glasses 110 display, by using subtitles, the text corresponding to the audio stream.

According to technical solutions provided in embodiments of the present disclosure, in the present disclosure, not only a voice in a real environment can be transcribed in real time, but also audio or video content played by a user terminal and a phone audio of a caller during a call can be transcribed in cooperation with a developed APP. The present disclosure makes augmented reality subtitle glasses no longer limited to an on-site conversation, but capable of assisting a user in understanding various media content, thereby expanding use scenarios. The present disclosure may also solve a problem of hearing-impaired people having difficulty in obtaining information during a call, allowing them to communicate on a phone as easily as normal people. The present disclosure provides a new possibility for application of augmented reality glasses in the barrier-free service field, focuses on humanistic care, and provides more personalized and convenient services for groups of different needs.

### Example Method

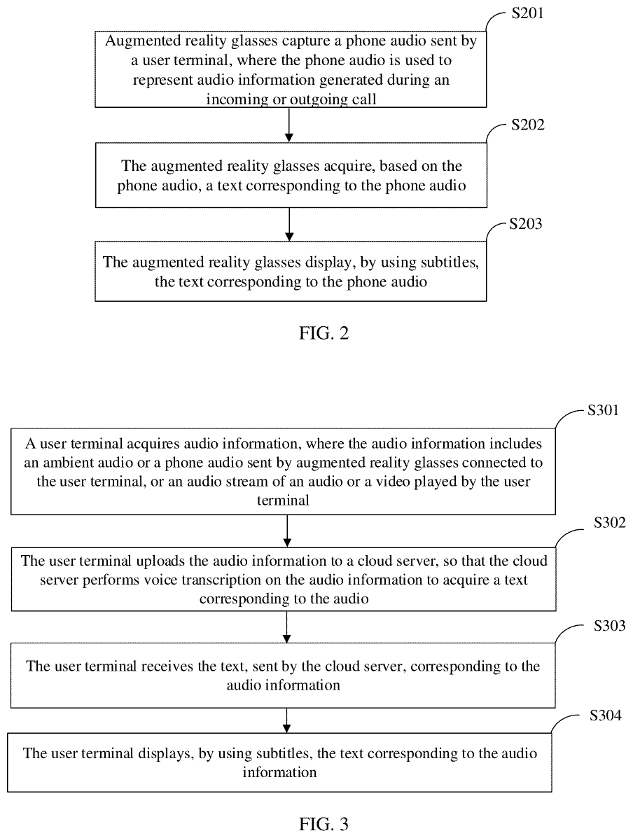

An embodiment of the present disclosure provides a subtitle display method. The subtitle display method may be applied to augmented reality glasses. As shown in FIG. 2, the subtitle display method may include the following steps.

Step S201: Augmented reality glasses capture a phone audio sent by a user terminal, where the phone audio is used to represent audio information generated during an incoming call or an outgoing call.

It should be understood that the augmented reality glasses may be in wired or wireless connection with the user terminal, for example, the wireless connection may be a Bluetooth connection, a WiFi connection, another wireless communication technology, or the like, which is not specifically limited in embodiments of the present disclosure. The user terminal may be a mobile phone, a tablet computer, or the like, which is not specifically limited in embodiments of the present disclosure. The phone audio may refer to audio information of a caller or a called party, or may refer to audio information of both parties of a call, which is not specifically limited in the present disclosure.

The augmented reality glasses in the present disclosure may use an array optical waveguide module as a display unit, to provide high light transmittance, ensuring that a user can clearly see the real world while reading subtitles. It should be noted that, considering comfort of wearing, the augmented reality glasses in the present disclosure may use a lightweight material and ergonomic design, to ensure that a user will not feel uncomfortable even if wearing the augmented reality glasses for a long time.

An application APP that matches the augmented reality glasses is disposed in the user terminal. In some embodiments, when there is an incoming call or an outgoing call, on the APP of the user terminal, a selection operation may be performed, to answer the call by using the augmented reality glasses. In this case, the APP of the user terminal may monitor a phone status, where the phone status may include incoming call, outgoing call, and call in progress. When the phone status changes from the incoming call (or outgoing call) to the call in progress, the APP of the user terminal sends a phone audio capture instruction to the augmented reality glasses, the augmented reality glasses capture a phone audio according to the phone audio capture instruction, and may also play the phone audio by using a speaker.

Step S202: The augmented reality glasses acquire, based on the phone audio, a text corresponding to the phone audio.

Specifically, in some embodiments, the augmented reality glasses may upload the phone audio to a cloud server by using WiFi, data traffic, or the like, so that the cloud server performs voice transcription on the phone audio to acquire the text corresponding to the phone audio and returns the text corresponding to the phone audio to the augmented reality glasses.

It should be noted that, the cloud server may perform speech recognition by using a speech recognition model, where the speech recognition model has a capability of adapting to a specific term, an accent, or a multi-language, so as to improve accuracy of speech recognition. In addition, the cloud server may further perform noise suppression and echo cancellation processing on an audio, so as to improve transcription quality in a noisy environment.

In some other embodiments, the augmented reality glasses may further send the phone audio to the user terminal. The user terminal acquires, based on the phone audio, the text corresponding to the phone audio, and sends the text corresponding to the phone audio to the augmented reality glasses. Specifically, the user terminal may upload the phone audio to the cloud server, so that the cloud server performs voice transcription on the phone audio to acquire the text corresponding to the phone audio. Alternatively, the user terminal may perform voice transcription on the phone audio to acquire the text corresponding to the phone audio, which is not specifically limited in embodiments of the present disclosure.

Specifically, the augmented reality glasses may encode the phone audio by using Opus, Advanced Audio Coding (AAC), or another encoder suitable for streaming, and send an encoded phone audio to the user terminal by using a wireless or wired connection.

For example, in some embodiments, considering privacy security of session content, a Bluetooth connection may be established between the augmented reality glasses and a smartphone by using a Bluetooth technology. This typically involves use of profiles such as Bluetooth SPP (Serial Port Profile) or BLE (Bluetooth Low Energy). In a Bluetooth transmission process, to ensure that communication content of a user is not accessed without authorization and data transmission is efficient and secure, an encryption technology is used to protect privacy in the transmission process.

Step S203: The augmented reality glasses display, by using subtitles, the text corresponding to the phone audio.

The augmented reality glasses receive text information from the user terminal and render the text information at a proper position of lens. Specifically, a clear font, an appropriate background transparency, and a color solution may be designed to ensure that the text information is clearly visible without excessively interfering with vision.

According to technical solutions provided in embodiments of the present disclosure, augmented reality glasses capture a phone audio sent by a user terminal, and acquire, based on the phone audio, a text corresponding to the phone audio; and the augmented reality glasses display, by using subtitles, the text corresponding to the phone audio. This can display subtitles during a call on lens of the augmented reality glasses in real time, assist user communication, and improve user experience. In particular, this can solve a problem of hearing-impaired people having difficulty in obtaining information during a call, allowing them to communicate on a phone as easily as normal people, greatly improving quality of life of hearing-impaired people, and helping them better integrate into society to enjoy colorful cultural life.

In some other embodiments, the augmented reality glasses may further receive a subtitle adjustment instruction sent by the user terminal, and perform adjustment of a position, a size, or a color on the subtitles according to the subtitle adjustment instruction. According to the technical solution provided in the embodiments, a user may adjust a font size, a color, and a position of subtitles according to a personal preference, so as to obtain best reading experience.

In some embodiments, the method further includes: acquiring, by the augmented reality glasses, a text corresponding to an audio stream of an audio or a video played by the user terminal; and displaying, by the augmented reality glasses by using subtitles, the text corresponding to the audio stream of the audio or the video.

In some embodiments, an APP, matching the augmented reality glasses, of a user terminal can provide a voice transcription service when another audio or video program of the user terminal runs, and text can be displayed on both the user terminal and the augmented reality glasses.

Specifically, the APP of the user terminal may invoke an Application Program Interface (API) provided by an operating system. For example, Accessibility Services of the Android system or VoiceOver of the iOS system enable the user terminal to capture audio output in a system range. When a video application or another audio or video of the user terminal is enabled, the APP of the user terminal may extract an audio stream of an audio or a video and upload the audio stream to the cloud server, so that the cloud server performs voice transcription on the audio stream to acquire a text corresponding to the audio stream and returns the text corresponding to the audio stream to the user terminal. The user terminal displays, by using subtitles, the text corresponding to the audio stream, and sends the text corresponding to the audio stream to the augmented reality glasses. The augmented reality glasses display, by using subtitles, the text corresponding to the audio stream.

In some embodiments, an interface of the APP may be suspended on another application in a form of a floating window or Picture-In-Picture (PIP), so that when the another application runs, a transcribed text is displayed in a floating box of the user terminal in real time.

It should be noted that, to optimize running resource use, efficient coding practices may be used to reduce CPU and memory usage of an application, and avoid redundant data processing. Tasks are properly allocated to different threads by using an appropriate data structure and algorithm, so as to avoid intensive computing tasks on a primary thread, thereby preventing an interface from freezing or lagging, and ensuring that resource occupation is minimized when the APP is running in a background.

According to technical solutions provided in embodiments of the present disclosure, an APP that can be suspended on a system and can also provide a continuous voice transcription service when another audio or video program on a mobile phone is running is developed, and a transcribed text is displayed on a user terminal and augmented reality glasses in real time, so that a seamless and efficient multitasking experience can be provided for a user. The augmented reality glasses may cooperate with the developed APP to transcribe audio or video content played by the user terminal, and assist a user in understanding various media content, thereby expanding use scenarios.

In some embodiments, the method further includes: capturing, by the augmented reality glasses by using a linear microphone array, an ambient audio by using a beamforming technology; acquiring, by the augmented reality glasses based on the ambient audio, a text corresponding to the ambient audio; and displaying, by the augmented reality glasses by using subtitles, the text corresponding to the ambient audio.

The ambient audio refers to ambient sound around the augmented reality glasses, such as dialogue sound, music, and effect sound. The augmented reality glasses are disposed with a linear microphone array, and the linear microphone array includes a plurality of microphone sensors. These sensors are distributed in a straight line, and can work together to implement more accurate sound capture and processing. For example, the linear microphone array may be distributed on an upper edge, a lower edge or the like of an eye lens frame. It should be understood that this is not specifically limited in the present disclosure. Compared with a conventional single or simple microphone structure, the linear microphone array can effectively improve spatial resolution of sound collection, and help to separate a target sound signal from background noise.

In addition, the augmented reality glasses may perform directional reception on the ambient audio by using a beamforming technology. The linear microphone array can amplify sound from a specific direction while suppressing noise in another direction. In this way, the glasses can “focus” on a specific sound source, such as a sound in front of a wearer.

In some embodiments, the augmented reality glasses may directly upload the ambient audio to the cloud server, so that the cloud server performs voice transcription on the ambient audio to obtain a text corresponding to the ambient audio. In some other embodiments, the augmented reality glasses may alternatively send the ambient audio to the user terminal. The user terminal uploads the ambient audio to the cloud server to acquire a text corresponding to the ambient audio, and sends the text corresponding to the ambient audio to the augmented reality glasses. The augmented reality glasses display, by using subtitles, the text corresponding to the ambient audio. It should be noted that, the augmented reality glasses may also send the text corresponding to the ambient audio to the user terminal, and the user terminal synchronously displays, in real time by using subtitles, the text corresponding to the ambient audio.

In some embodiments, the method further includes: performing, by the augmented reality glasses, signal processing on the ambient audio, where the signal processing includes at least one of following: filtering processing, noise reduction processing, or echo cancellation processing. The acquiring, by the augmented reality glasses based on the ambient audio, a text corresponding to the ambient audio includes: acquiring, by the augmented reality glasses based on an ambient audio obtained after the signal processing, the text corresponding to the ambient audio.

In other words, the augmented reality glasses may integrate advanced signal processing algorithms, such as an adaptive filter, a noise reduction algorithm, an echo cancellation algorithm, or the like to further improve sound quality of the ambient audio. This may effectively reduce ambient noise and ensure clear speech input, thereby improving accuracy of speech recognition.

In some embodiments, the method further includes: performing, by the augmented reality glasses, parameter adjustment by using a depth learning model or a machine learning model, where the parameter adjustment includes at least one of following: beamforming parameter adjustment or signal processing parameter adjustment. The capturing an ambient audio by using a beamforming technology includes: capturing the ambient audio by using an adjusted beamforming parameter. The performing, by the augmented reality glasses, signal processing on the ambient audio includes: performing, by the augmented reality glasses, signal processing on the ambient audio based on an adjusted signal processing parameter.

In other words, in embodiments of the present disclosure, a machine learning mechanism or a deep learning mechanism may be introduced, and parameters are automatically adjusted depending on different environments and scenarios and by using a deep learning model or a machine learning model, so as to obtain an optimal sound reception effect.

It should be noted that, in technical solutions provided in embodiments of the present disclosure, the glasses will not add burden, for example, designed to be light and keeping a long battery life, so as to avoid affecting user comfort and convenience.

According to technical solutions provided in embodiments of the present disclosure, an advanced linear microphone array, an advanced signal processing algorithm, and a machine learning model or a deep learning model are integrated, so that a more efficient and accurate voice capture capability in a noisy environment is provided in the present disclosure, thereby improving accuracy of speech recognition. Even in a very noisy environment, such as a concert or a sports event, clear text transcription can be obtained, which greatly improves an information acquisition ability of hearing-impaired people.

Another embodiment of the present disclosure provides a subtitle display method. The subtitle display method may be applied to a user terminal. As shown in FIG. 3, the subtitle display method may include the following steps.

Step S301: A user terminal acquires audio information, where the audio information includes an ambient audio or a phone audio sent by augmented reality glasses connected to the user terminal, or an audio stream of an audio or a video played by the user terminal.

The phone audio is used to represent audio information generated during an incoming call or an outgoing call.

The ambient audio refers to ambient sound around the augmented reality glasses, such as dialogue sound, music, effect sound, or the like.

An APP that matches the augmented reality glasses is disposed in the user terminal, and the APP of the user terminal may invoke an API provided by an operating system. For example, Accessibility Services of the Android system or VoiceOver of the iOS system enable the user terminal to capture audio output in a system range. When a video application or another audio or video of the user terminal is enabled, the APP of the user terminal may extract related audio streams of an audio or a video.

Step S302: The user terminal uploads the audio information to a cloud server, so that the cloud server performs voice transcription on the audio information to acquire a text corresponding to the audio information.

The cloud server may perform speech recognition by using a speech recognition model, where the speech recognition model has a capability of adapting to a specific term, an accent, or a multi-language, so as to improve accuracy of speech recognition. In addition, the cloud server may further perform noise suppression and echo cancellation processing on an audio, so as to improve transcription quality in a noisy environment.

Step S303: The user terminal receives the text, sent by the cloud server, corresponding to the audio information.

Step S304: The user terminal displays, by using subtitles, the text corresponding to the audio information.

In some embodiments, the user terminal displays, in a floating box by using subtitles, the text corresponding to the audio information. Specifically, an interface of the APP may be suspended on another application in a form of a floating window or picture-in-picture (PIP), so that when the another application runs, a transcribed text is displayed in the floating box of the user terminal in real time.

According to technical solutions provided in embodiments of the present disclosure, the user terminal not only can transcribe a voice in a real environment in real time, but also can transcribe, in cooperation with a developed APP, audio or video content played by the user terminal and a phone audio of a caller during a call, and assist a user in understanding various media content, thereby expanding use scenarios. The user terminal may also solve a problem of hearing-impaired people having difficulty in obtaining information during a call, allowing them to communicate on a phone as easily as normal people.

In some embodiments, the method further includes: sending, by the user terminal, the text corresponding to the audio information to the augmented reality glasses, so that the augmented reality glasses displaying, by using subtitles, the text corresponding to the audio information.

The text corresponding to the audio information is displayed on lens of the augmented reality glasses, which can assist user communication, and improve user experience, especially can improve quality of life of hearing-impaired people, and help them better integrate into society to enjoy colorful cultural life.

In some embodiments, the method further includes: when there is an incoming call or an outgoing call, monitoring, by the user terminal, a phone status, where the phone status includes incoming call, outgoing call, and call in progress; and when the phone status is call in progress, sending, by the user terminal, a phone audio capture instruction to the augmented reality glasses, so that the augmented reality glasses capturing the phone audio according to the phone audio capture instruction.

An application APP that matches the augmented reality glasses is disposed in the user terminal. In some embodiments, when there is an incoming call or an outgoing call, on the APP of the user terminal, a selection operation may be performed, to answer the call by using the augmented reality glasses. In this case, the APP of the user terminal may monitor a phone status, where the phone status may include incoming call, outgoing call, and call in progress. When the phone status changes from the incoming call (or outgoing call) to the call in progress, the APP of the user terminal sends the phone audio capture instruction to the augmented reality glasses, the augmented reality glasses capture the phone audio according to the phone audio capture instruction, and may also play the phone audio by using a speaker.

In some embodiments, the method further includes: sending, by the user terminal, a subtitle adjustment instruction to the augmented reality glasses, so that the augmented reality glasses perform adjustment of a position, a size, or a color on the subtitles according to the subtitle adjustment instruction. According to the technical solution provided in the embodiments, a user may adjust a font size, a color, and a position of subtitles according to a personal preference, so as to obtain best reading experience.

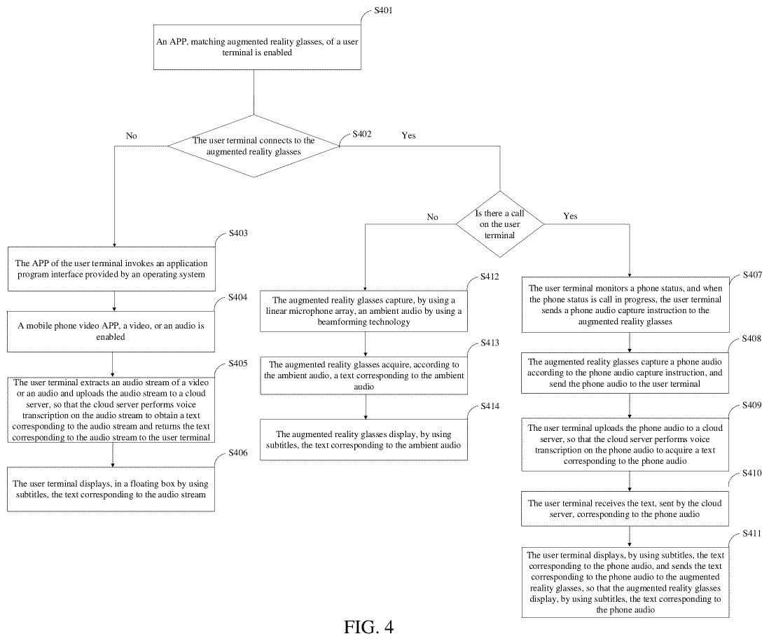

Another embodiment of the present disclosure provides a subtitle display method. The subtitle display method is a specific example of embodiments illustrated in FIG. 2. As shown in FIG. 4, the subtitle display method may include the following steps.

Step S401: An APP, matching augmented reality glasses, of a user terminal is enabled.

Step S402: The user terminal connects to the augmented reality glasses.

Specifically, the user terminal may be in wired or wireless connection with the augmented reality glasses. The wireless connection may be a Bluetooth connection, a WiFi connection, another wireless communication technology or the like, which is not specifically limited in embodiments of the present disclosure.

When the user terminal is not connected to the augmented reality glasses, Step S403 to Step S406 may be performed.

Step S403: The APP of the user terminal invokes an application program interface provided by an operating system.

Step S404: A mobile phone video APP, a video, or an audio is enabled.

Step S405: The user terminal extracts an audio stream of a video or an audio and uploads the audio stream to a cloud server, so that the cloud server performs voice transcription on the audio stream to obtain a text corresponding to the audio stream and returns the text corresponding to the audio stream to the user terminal.

Step S406: The user terminal displays, in a floating box by using subtitles, the text corresponding to the audio stream.

It should be understood that, when the user terminal is connected to the augmented reality glasses, the user terminal may further send the text corresponding to the audio stream to the augmented reality glasses, and the text corresponding to the audio stream is synchronously displayed on the augmented reality glasses.

In addition, after the user terminal is connected to the augmented reality glasses, when there is an incoming call on the user terminal, Step S407 to Step S411 are performed.

Step S407: The user terminal monitors a phone status, and when the phone status is call in progress, the user terminal sends a phone audio capture instruction to the augmented reality glasses.

When there is a call on the user terminal, on the APP of the user terminal, a selection operation may be performed, to answer the call by using the augmented reality glasses. In this case, the APP of the user terminal may monitor the phone status, where the phone status may include incoming call, outgoing call, and call in progress. When the phone status changes from the incoming call (or outgoing call) to the call in progress, the APP of the user terminal sends the phone audio capture instruction to the augmented reality glasses.

Step S408: The augmented reality glasses capture a phone audio according to the phone audio capture instruction, and send the phone audio to the user terminal.

Step S409: The user terminal uploads the phone audio to a cloud server, so that the cloud server performs voice transcription on the phone audio to acquire a text corresponding to the phone audio.

Step S410: The user terminal receives the text, sent by the cloud server, corresponding to the phone audio.

Step S411: The user terminal displays, by using subtitles, the text corresponding to the phone audio, and sends the text corresponding to the phone audio to the augmented reality glasses, so that the augmented reality glasses display, by using subtitles, the text corresponding to the phone audio.

It should be understood that, the augmented reality glasses may alternatively upload the phone audio to the cloud server by using WiFi, data traffic, or the like, so that the cloud server performs voice transcription on the phone audio to acquire the text corresponding to the phone audio and returns the text corresponding to the phone audio to the augmented reality glasses. This is not specifically limited in embodiments of the present disclosure.

When there is no incoming call on the user terminal, Step S412 to Step S414 are performed.

Step S412: The augmented reality glasses capture, by using a linear microphone array, an ambient audio by using a beamforming technology.

Step S413: The augmented reality glasses acquire, according to the ambient audio, a text corresponding to the ambient audio.

In some embodiments, the augmented reality glasses may directly upload the ambient audio to the cloud server, so that the cloud server performs voice transcription on the ambient audio to obtain a text corresponding to the ambient audio and returns the text corresponding to the ambient audio to the augmented reality glasses. In some other embodiments, the augmented reality glasses may alternatively send the ambient audio to the user terminal. The user terminal uploads the ambient audio to the cloud server to acquire a text corresponding to the ambient audio, and then sends the text corresponding to the ambient audio to the augmented reality glasses.

Step S414: The augmented reality glasses display, by using subtitles, the text corresponding to the ambient audio.

It should be noted that, the augmented reality glasses may also send the text corresponding to the ambient audio to the user terminal, and the user terminal synchronously displays, in real time by using subtitles, the text corresponding to the ambient audio.

According to technical solutions provided in embodiments of the present disclosure, in the present disclosure, not only a voice in a real environment can be transcribed in real time, but also audio or video content played by a user terminal and a phone audio of a caller during a call can be transcribed in cooperation with a developed APP. This feature makes augmented reality subtitle glasses no longer limited to an on-site conversation, but capable of assisting a user in understanding various media content, thereby expanding use scenarios. This feature may also solve a problem of hearing-impaired people having difficulty in obtaining information during a call, allowing them to communicate on a phone as easily as normal people.

### Example Apparatus, Electronic Device, Storage Medium, and Software

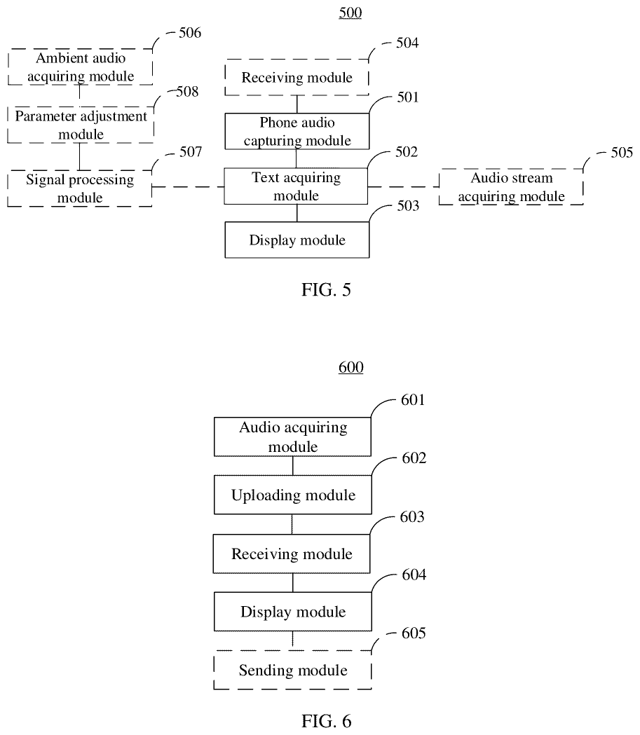

An embodiment of the present disclosure further provides a subtitle display apparatus. The subtitle display apparatus may be applied to augmented reality glasses, and the augmented reality glasses may be connected to a user terminal. As shown in FIG. 5, the subtitle display apparatus 500 may include a phone audio capturing module 501, a text acquiring module 502, and a display module 503.

The phone audio capturing module 501 is configured for the augmented reality glasses to capture a phone audio sent by a user terminal, where the phone audio is used to represent audio information generated during an incoming call or an outgoing call.

The text acquiring module 502 is configured for the augmented reality glasses to acquire, based on the phone audio, a text corresponding to the phone audio.

The display module 503 is configured for the augmented reality glasses to display, by using subtitles, the text corresponding to the phone audio.

According to technical solutions provided in embodiments of the present disclosure, augmented reality glasses capture a phone audio sent by a user terminal, and acquire, based on the phone audio, a text corresponding to the phone audio; and the augmented reality glasses display, by using subtitles, the text corresponding to the phone audio. This can display subtitles during a call on lens of the augmented reality glasses in real time, assist user communication, and improve user experience, especially can improve quality of life of hearing-impaired people, and help them better integrate into society to enjoy colorful cultural life.

In some embodiments, the subtitle display apparatus further includes a receiving module 504, configured for the augmented reality glasses to receive a phone audio capture instruction sent by the user terminal when a phone status is call in progress. The phone audio capturing module 501 is configured for the augmented reality glasses to capture the phone audio according to the phone audio capture instruction.

In some embodiments, the text acquiring module 502 is configured for the augmented reality glasses to send the phone audio to the user terminal, so that the user terminal acquires, based on the phone audio, the text corresponding to the phone audio, and sends the text corresponding to the phone audio to the augmented reality glasses.

In some embodiments, the text acquiring module 502 is configured for the augmented reality glasses to upload the phone audio to a cloud server, so that the cloud server performs voice transcription on the phone audio to acquire the text corresponding to the phone audio and returns the text corresponding to the phone audio to the augmented reality glasses.

In some embodiments, the subtitle display apparatus further includes an audio stream acquiring module 505, configured for the augmented reality glasses to acquire a text corresponding to an audio stream of an audio or a video played by the user terminal. The display module 503 is further configured for the augmented reality glasses to display, by using subtitles, the text corresponding to the audio stream of the audio or the video.

In some embodiments, the subtitle display apparatus further includes an ambient audio acquiring module 506, configured for the augmented reality glasses to capture, by using a linear microphone array, an ambient audio by using a beamforming technology. The text acquiring module 502 is further configured for the augmented reality glasses to acquire, based on the ambient audio, a text corresponding to the ambient audio. The display module 503 is further configured for the augmented reality glasses to display, by using subtitles, the text corresponding to the ambient audio.

In some embodiments, the subtitle display apparatus further includes a signal processing module 507, configured for the augmented reality glasses to perform signal processing on the ambient audio, where the signal processing includes at least one of following: filtering processing, noise reduction processing, or echo cancellation processing. The text acquiring module 502 is configured for the augmented reality glasses to acquire, based on an ambient audio obtained after the signal processing, the text corresponding to the ambient audio.

In some embodiments, the subtitle display apparatus further includes a parameter adjustment module 508, configured for the augmented reality glasses to perform parameter adjustment by using a depth learning model or a machine learning model, where the parameter adjustment includes at least one of following: beamforming parameter adjustment or signal processing parameter adjustment. The ambient audio acquiring module 506 is configured to capture the ambient audio by using an adjusted beamforming parameter. The signal processing module 507 is configured for the augmented reality glasses to perform signal processing on the ambient audio based on an adjusted signal processing parameter.

In some embodiments, the receiving module 504 is further configured for the augmented reality glasses to receive a subtitle adjustment instruction sent by the user terminal, and perform adjustment of a position, a size, or a color on the subtitles according to the subtitle adjustment instruction.

For an embodiment process of functions and effects of the modules in the apparatus in the embodiment illustrated in FIG. 5, specifically refer to an embodiment process of corresponding steps in the method in the embodiment illustrated in FIG. 2. Details are not described herein again.

Another embodiment of the present disclosure further provides a subtitle display apparatus. The subtitle display apparatus may be applied to a user terminal. As shown in FIG. 6, the subtitle display apparatus 600 may include an audio acquiring module 601, an uploading module 602, a receiving module 603, and a display module 604.

The audio acquiring module 601 is configured for the user terminal to acquire audio information, where the audio information includes an ambient audio or a phone audio sent by augmented reality glasses connected to the user terminal, or an audio stream of an audio or a video played by the user terminal.

The uploading module 602 is configured for the user terminal to upload the audio information to a cloud server, so that the cloud server performs voice transcription on the audio information to acquire a text corresponding to the audio information.

The receiving module 603 is configured for the user terminal to receive the text, sent by the cloud server, corresponding to the audio information.

The display module 604 is configured for the user terminal to display, by using subtitles, the text corresponding to the audio information.

According to technical solutions provided in embodiments of the present disclosure, the user terminal not only can transcribe a voice in a real environment in real time, but also can transcribe, in cooperation with a developed APP, audio or video content played by the user terminal and a phone audio of a caller during a call, and assist a user in understanding various media content, thereby expanding use scenarios. The present disclosure may also solve a problem of hearing-impaired people having difficulty in obtaining information during a call, allowing them to communicate on a phone as easily as normal people.

In some embodiments, the subtitle display apparatus further includes a sending module 605, configured for the user terminal to send the text corresponding to the audio information to the augmented reality glasses, so that the augmented reality glasses display, by using subtitles, the text corresponding to the audio information.

In some embodiments, the display module 604 is configured for the user terminal to display, in a floating box by using subtitles, the text corresponding to the audio information.

In some embodiments, the subtitle display apparatus further includes a monitoring module 606, configured for the user terminal to monitor a phone status when there is an incoming call or an outgoing call. The sending module 605 is configured for the user terminal to: when the phone status is call in progress, send a phone audio capture instruction to the augmented reality glasses, so that the augmented reality glasses capture a phone audio according to the phone audio capture instruction.

In some embodiments, the sending module 605 is further configured for the user terminal to send a subtitle adjustment instruction to the augmented reality glasses, so that the augmented reality glasses perform adjustment of a position, a size, or a color on the subtitles according to the subtitle adjustment instruction.

For an embodiment process of functions and effects of the modules in the apparatus in the embodiment illustrated in FIG. 6, specifically refer to an embodiment process of corresponding steps in the method in the embodiment illustrated in FIG. 3. Details are not described herein again.

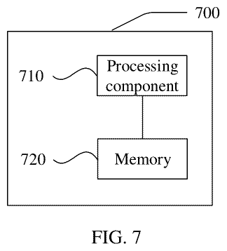

FIG. 7 is a block diagram of an electronic device 700 according to an embodiment of the present disclosure.

Referring to FIG. 7, the electronic device 700 includes a processing component 710, and further includes one or more processors, as well as a memory resource represented by a memory 720, which is configured to store an instruction, for example, an application, executable by the processing component 710. The application program stored in the memory 720 may include one or more modules each corresponding to a set of instructions. In addition, the processing component 710 is configured to execute instructions, so as to execute the subtitle display method in any one of the foregoing embodiments.

The electronic device 700 may further include: a power supply component, configured to perform power management of the electronic device 700; a wired or wireless network interface, configured to connect the electronic device 700 to a network; and an input/output (I/O) interface. The electronic device 700 may be operated based on an operating system stored in the memory 720, such as Windows Server™, Mac OS X™, Unix™, Linux™, FreeBSD™, or the like. In some embodiments, the electronic device includes augmented reality glasses.

In some embodiments, the augmented reality glasses include a linear microphone array, and the linear microphone array includes a plurality of microphone sensors distributed along a straight line.

In some embodiments, the augmented reality glasses include wearing glasses for a hearing-impaired person.

An embodiment of the present disclosure further provides a non-transitory computer-readable storage medium, and the non-transitory computer-readable storage medium stores a computer program. When the computer program is executed on a computer, the computer is caused to execute the subtitle display method in any one of the foregoing embodiments.

An embodiment of the present disclosure further provides a computer program product that includes instructions, and when the instructions are executed by a computer, the computer is caused to execute the subtitle display method in any one of the foregoing embodiments.

It may be understood that, specific examples in this specification are merely intended to help a person skilled in the art better understand embodiments of the present disclosure, and are not intended to limit the scope of the present disclosure.

It may be understood that in various embodiments of the present disclosure, sequence numbers of the processes do not mean execution sequences. The execution sequences of the processes should be determined according to functions and internal logic of the processes, and should not be construed as any limitation on the embodiment processes of embodiments of the present disclosure.

It may be understood that various embodiments described in the present disclosure may be implemented separately or in combination, which is not limited in the present disclosure.

Unless otherwise stated, all technical and scientific terms used in embodiments of the present disclosure have the same meaning as commonly understood by those skilled in the technical field of the present disclosure. The terms used in the present disclosure are merely for the purpose of describing specific embodiments, and are not intended to limit the present disclosure. The term “and/or” used in the present disclosure includes any and all combinations of one or more related listed items. The singular forms of “a/an”, “said”, and “the” used in embodiments of the present disclosure and the appended claims are also intended to include plural forms, unless the context clearly implies otherwise.

It may be understood that, a processor in embodiments of the present disclosure may be an integrated circuit chip having a signal processing capability. In an embodiment process, the steps in the foregoing method embodiments may be performed by using an integrated logic circuit of hardware of the processor or instructions in a software form. The foregoing processor may be a general purpose processor, a Digital Signal Processor (DSP), an Application Specific Integrated Circuit (ASIC), a Field Programmable Gate Array (FPGA) or another programmable logic device, a discrete gate or a transistor logic device, or a discrete hardware component. The methods, the steps, and logical block diagrams that are disclosed in embodiments of the present disclosure may be implemented or performed. The general-purpose processor may be a microprocessor, or the processor may be any conventional processor or the like. The steps of the methods disclosed with reference to embodiments of the present disclosure may be directly performed by a hardware decoding processor, or may be performed by using a combination of hardware and software modules in the decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of the present disclosure may be a volatile memory or a non-volatile memory, or may include both a volatile memory and a non-volatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), or a flash memory. The volatile memory may be a Random Access Memory (RAM). It should be noted that, the memory in the systems and methods described in this specification includes but is not limited to these memories and any memory of another proper type.

A person of ordinary skill in the art may recognize that, with reference to the examples described in embodiments disclosed in this specification, units and algorithm steps may be implemented by using electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the embodiment goes beyond the scope of the present disclosure.

Those skilled in the art may clearly understand that, for the purpose of convenient and brief description, for detailed working processes of the foregoing system, apparatus, and unit, reference may be made to the corresponding processes in the foregoing method embodiments, and details are not described herein again.

In several embodiments provided in the present disclosure, it should be understood that the disclosed system, apparatus, and method may be implemented in other manners. For example, the described apparatus embodiments are merely examples. For example, the unit division is merely logical function division and may be other division in actual embodiment. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electronic, mechanical, or other forms.

The units described as separate parts may or may not be physically separate, and parts displayed as units may or may not be physical units, and may be at one location, or may be distributed on a plurality of network elements. Some or all of the units may be selected according to actual requirements to achieve the objective of the solutions of embodiments.

In addition, function units in embodiments of the present disclosure may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such understanding, the technical solutions of the present disclosure essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of the present disclosure. The foregoing storage medium includes any medium that can store program code, such as a USB flash drive, a removable hard disk, a Read-Only Memory (ROM), a Random Access Memory (RAM), a magnetic disk, or an optical disc.

The foregoing descriptions are merely specific embodiments of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A subtitle display method, applied to augmented reality glasses, wherein the augmented reality glasses are connected to a user terminal, and the method comprises:
capturing, by the augmented reality glasses, a phone audio sent by the user terminal, wherein the phone audio is used to represent audio information generated during an incoming call or an outgoing call;
acquiring, by the augmented reality glasses based on the phone audio, a text corresponding to the phone audio; and
displaying, by the augmented reality glasses by using subtitles, the text corresponding to the phone audio.

2. The method according to claim 1, further comprising:
when a phone status is call in progress, receiving, by the augmented reality glasses, a phone audio capture instruction sent by the user terminal,
wherein the capturing, by the augmented reality glasses, a phone audio sent by the user terminal comprises:
capturing, by the augmented reality glasses, the phone audio according to the phone audio capture instruction.

3. The method according to claim 1, wherein the acquiring, by the augmented reality glasses based on the phone audio, a text corresponding to the phone audio comprises:
sending, by the augmented reality glasses, the phone audio to the user terminal, so that the user terminal acquires, based on the phone audio, the text corresponding to the phone audio and sends the text corresponding to the phone audio to the augmented reality glasses.

4. The method according to claim 1, wherein the acquiring, by the augmented reality glasses based on the phone audio, a text corresponding to the phone audio comprises:
uploading, by the augmented reality glasses, the phone audio to a cloud server, so that the cloud server performs voice transcription on the phone audio to acquire the text corresponding to the phone audio and returns the text corresponding to the phone audio to the augmented reality glasses.

5. The method according to claim 1, further comprising:
acquiring, by the augmented reality glasses, a text corresponding to an audio stream of an audio or a video played by the user terminal; and
displaying, by the augmented reality glasses by using subtitles, the text corresponding to the audio stream of the audio or the video.

6. The method according to claim 1, further comprising:
capturing, by the augmented reality glasses by using a linear microphone array, an ambient audio by using a beamforming technology;
acquiring, by the augmented reality glasses based on the ambient audio, a text corresponding to the ambient audio; and
displaying, by the augmented reality glasses by using subtitles, the text corresponding to the ambient audio.

7. The method according to claim 6, further comprising:
performing, by the augmented reality glasses, signal processing on the ambient audio, wherein the signal processing comprises at least one of following: filtering processing, noise reduction processing, or echo cancellation processing,
wherein the acquiring, by the augmented reality glasses based on the ambient audio, a text corresponding to the ambient audio comprises:
acquiring, by the augmented reality glasses based on an ambient audio obtained after the signal processing, the text corresponding to the ambient audio.

8. The method according to claim 7, further comprising:
performing, by the augmented reality glasses, parameter adjustment by using a depth learning model or a machine learning model, wherein the parameter adjustment comprises at least one of following: beamforming parameter adjustment or signal processing parameter adjustment,
wherein the capturing an ambient audio by using a beamforming technology comprises:
capturing the ambient audio by using an adjusted beamforming parameter; and
wherein the performing, by the augmented reality glasses, signal processing on the ambient audio comprises:
performing, by the augmented reality glasses, signal processing on the ambient audio based on an adjusted signal processing parameter.

9. The method according to claim 1, further comprising:
receiving, by the augmented reality glasses, a subtitle adjustment instruction sent by the user terminal, and performing adjustment of a position, a size, or a color on the subtitles according to the subtitle adjustment instruction.

10. A subtitle display method, comprising:
acquiring, by a user terminal, audio information, wherein the audio information comprises an ambient audio or a phone audio sent by augmented reality glasses connected to the user terminal, or an audio stream of an audio or a video played by the user terminal;
uploading, by the user terminal, the audio information to a cloud server, so that the cloud server performs voice transcription on the audio information to acquire a text corresponding to the audio information;
receiving, by the user terminal, the text, sent by the cloud server, corresponding to the audio information; and
displaying, by the user terminal by using subtitles, the text corresponding to the audio information.

11. The method according to claim 10, further comprising:
sending, by the user terminal, the text corresponding to the audio information to the augmented reality glasses, so that the augmented reality glasses display, by using subtitles, the text corresponding to the audio information.

12. The method according to claim 10, wherein the displaying, by the user terminal by using subtitles, the text corresponding to the audio information comprises:
displaying, by the user terminal in a floating box by using subtitles, the text corresponding to the audio information.

13. The method according to claim 10, further comprising:
when there is an incoming call or an outgoing call, monitoring, by the user terminal, a phone status; and
when the phone status is call in progress, sending, by the user terminal, a phone audio capture instruction to the augmented reality glasses, so that the augmented reality glasses capture the phone audio according to the phone audio capture instruction.

14. The method according to claim 10, further comprising:
sending, by the user terminal, a subtitle adjustment instruction to the augmented reality glasses, so that the augmented reality glasses perform adjustment of a position, a size, or a color on the subtitles according to the subtitle adjustment instruction.

15. An electronic device, comprising:
a processor; and
a memory, configured to store executable instructions of the processor,
wherein the processor is configured to execute the subtitle display method according to claim 1.

16. The electronic device according to claim 15, wherein the electronic device comprises augmented reality glasses.

17. The electronic device according to claim 16, wherein the augmented reality glasses comprise a linear microphone array, and the linear microphone array comprises a plurality of microphone sensors distributed along a straight line.

18. The electronic device according to claim 16, wherein the augmented reality glasses comprise wearing glasses for a hearing-impaired person.

19. An electronic device, comprising:
a processor; and
a memory, configured to store executable instructions of the processor,
wherein the processor is configured to execute the subtitle display method according to claim 10.

20. A subtitle display system, comprising augmented reality glasses, a user terminal, and a cloud server,
wherein the user terminal is configured to obtain audio information, the audio information comprises an ambient audio or a phone audio sent by the augmented reality glasses, or an audio stream of an audio or a video played by the user terminal;
the user terminal is further configured to upload the audio information to the cloud server, so that the cloud server performs voice transcription on the audio information to acquire a text corresponding to the audio information and returns the text corresponding to the audio information to the user terminal;
the user terminal is further configured to display, by using subtitles, the text corresponding to the audio information, and send the text corresponding to the audio information to the augmented reality glasses; and
the augmented reality glasses are configured to display, by using subtitles, the text corresponding to the audio information.
